(19) United States
(12) Patent Application Publication
(10) Pub. No.: US 2013/0309025 A1
(43) Pub. Date: Nov. 21, 2013

(54) CASSETTE FOR A MILLING CUTTER

(71) Applicant: Kennametal Inc., Latrobe, PA (US)

(72) Inventors: Armin Josef Zimmermann, Aberviechtach (DE); Xaver Spichtinger, Aberviechtach (DE); Johann Schneider, Gleiritsch (DE)

(73) Assignee: Kennametal Inc., Latrobe, PA (US)

(21) Appl. No.: 13/894,497

(22) Filed: May 15, 2013

(30) Foreign Application Priority Data
May 16, 2012 (DE) 102012009739.5

(51) Int. Cl. B23C 5/22; B23C 5/28

(52) U.S. Cl. CPC B23C 5/22; B23C 5/28
USPC 407/11; 407/46

(57) ABSTRACT

The invention relates to a cassette for a milling cutter, having a cutter carrier and a clamping part, which together constitute a generally rectangular cassette, the cutter carrier and the clamping part being loosely placed on each other and together delimiting a fastening opening for a fastening screw by means of which the cassette can be fastened in a receiver of a milling cutter, the cutter carrier having a seat for a cutting insert. The invention additionally relates to a milling cutter having at least one receiver for a cassette and having at least one such cassette.

### FIELD OF THE INVENTION

The invention relates to a cassette for a milling cutter, by means of which a cutting insert can be adjustably attached to the milling cutter. The invention additionally relates to a milling cutter having such a cassette.

### BACKGROUND OF THE INVENTION

Such a milling cutter having a cassette is known in principle from EP 1 753 577 B1. The cassette can be adjustably mounted in a receiver on the milling cutter by means of a fastening screw and an adjusting screw. When the cutting insert of the cassette has become worn, the cutting insert can be remachined, or the entire cassette has to be replaced.

### SUMMARY OF THE INVENTION

The object of the invention consists in developing the known cassette in such a way that the economic efficiency of the milling cutter system used is increased.

To achieve this object, there is provided according to the invention a cassette for a milling cutter, having a cutter carrier and a clamping part, which together constitute a generally rectangular cassette, the cutter carrier and the clamping part being loosely placed on each other and together delimiting a fastening opening for a fastening screw by means of which the cassette can be fastened in a receiver of a milling cutter, the cutter carrier having a seat for a cutting insert. The invention is based on the fundamental concept of dividing the hitherto known cassette into two parts that are placed loosely on each other, of which one carries the cutting insert and the other effects clamping and support. Both parts together, as a whole, constitute the cassette, which, in respect of its dimensions, corresponds to the hitherto known cassette. Consequently the cassettes used hitherto can be replaced by the new cassettes. The particular advantage of the new, divided cassettes consists in that, in the case of wear, only a part of the cassette need be replaced, namely the cutter carrier, while the other part, i.e. the clamping part, can continue to be used. As a result, the operating costs are reduced.

According to one embodiment, it is provided that the cutting insert is fixedly mounted on the cutter carrier, in particular soldered or adhesive-bonded into the seat. This is advantageous, in particular, if cutting inserts made of PCD (polycrystalline diamond) are used.

According to an alternative embodiment, it is provided that the cutting insert is inserted in the seat on the cutter carrier. This enables the operating costs to be reduced yet further, since, in the case of wear, it is only the cutting insert, and not the cutter carrier, that has to be replaced.

Preferably, it is provided that the cutting insert is locked positively, in the seat, against displacement in at least one direction. Consequently, the cutting insert is then already reliably fixed in the seat even when the cassette has only been premounted in a preliminary manner on the milling cutter and has not yet been finally clamped.

According to one design of the invention, it is provided that the clamping part has a support portion, which defines an outside face of the cassette that faces away from the seat for the cutting insert. This ensures that a continuous, undivided surface is available for positioning the cassette.

It is preferably provided in this case that the support portion terminates just above the bottom surface of the cutter carrier. This prevents a mechanical overdetermination from coming about when the cassette is in the mounted state.

According to a preferred embodiment of the invention, it is provided that the parting line between the cutter carrier and the clamping part, in relation to a center line of the fastening opening, runs closer to the clamping part than to the cutter carrier. This offset, which, in particular, can be in the order of magnitude of 20% of the smallest diameter of the fastening opening, has proved to be particularly advantageous in a mechanical respect.

Preferably, it is provided that the clamping part has a clamping surface that is located at the end of the clamping part facing away from the support portion, and that is supported on the cutter carrier in the region of the seat, or close to the latter. The clamping surface can be used, on the one hand, to transfer the exerted clamping force on to the cutter carrier. If a separate cutting insert, inserted in the seat, is used, the clamping surface can be used, on the other hand, to clamp the cutting insert in the seat.

According to a preferred embodiment of the invention, there is a slot between the cutter part and the clamping part, which slot extends, starting from the clamping portion, beyond the region of the fastening opening, to the support portion. The slot also serves to prevent overdeterminations, such that it is reliably ensured that the desired clamping force is applied via the clamping surface.

According to one embodiment of the invention, at least one coolant channel is provided in the clamping part. This enables coolant to be supplied to a cutter on the cutting insert.

The coolant channel can extend from a side surface of the clamping part to an outer surface of the clamping part that is disposed above the seat for the cutting insert. It can also be provided that the coolant channel extends from a top side of the clamping part to this outer surface. The course of the coolant channel can thus be adapted in a flexible manner to the milling cutter and to the arrangement of coolant supply openings on the milling cutter.

### BRIEF DESCRIPTION OF THE DRAWINGS

The invention is described in the following on the basis of various embodiments, which are represented in the appended drawings. In the drawings:

FIG. 1 shows a schematic bottom view of a milling cutter according to the invention, having cassettes according to the invention;

FIG. 2 shows the milling cutter from FIG. 1, in a side view;

FIG. 3 shows the milling cutter from FIG. 1, in a perspective view;

FIG. 4 shows a side view of a cassette according to the invention;

FIG. 5 shows a top view of the cassette from FIG. 4;

FIG. 6 shows a front view of the cassette from FIG. 4;

FIG. 7 shows a first perspective view of a cassette according to a first embodiment of the invention;

FIG. 8 shows a second perspective view of the cassette according to the first embodiment;

FIG. 9 shows the cutter carrier of the cassette according to the first embodiment, in a perspective view;

FIG. 10 shows the clamping part of the cassette according to the first embodiment, in a perspective view;

FIG. 11 shows a perspective view of a cassette according to a second embodiment;

FIG. 12 shows a perspective view of a cassette according to a third embodiment; and

FIG. 13 shows a broken top view of a cutter carrier with a cutting insert for a cassette, according to a fourth embodiment.

### DETAILED DESCRIPTION OF THE INVENTION

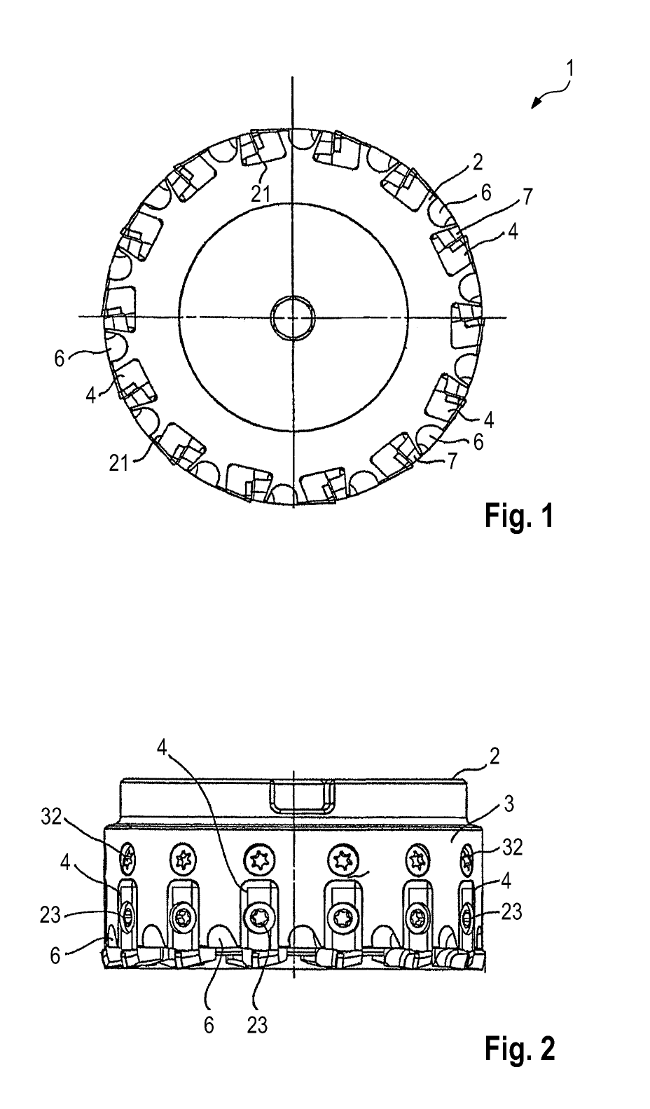

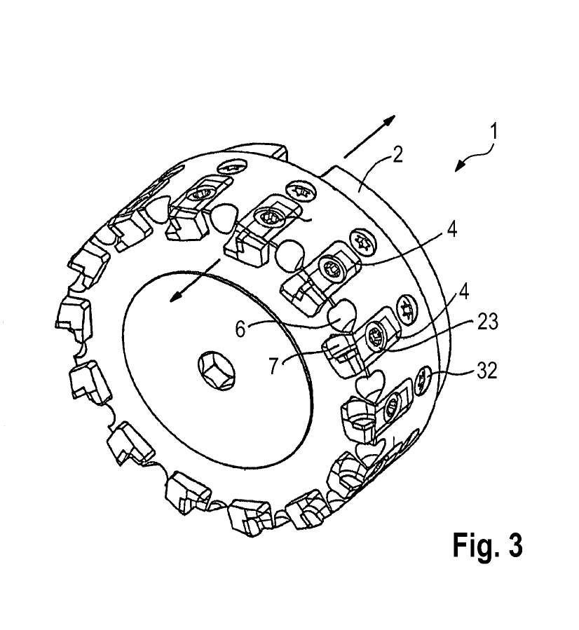

FIGS. 1 to 3 show a milling cutter 1, which has a tool basic body 2 having the general shape of a cylinder, or hollow cylinder. The tool basic body can be composed of aluminum, titanium, steel or another suitable material. On its lateral circumferential surface 3, the tool basic body 2 carries a multiplicity of cassettes 4, which are disposed in a uniformly distributed manner on the outer circumference of the tool basic body 2. Alternatively, it is possible for the cassettes 4 to be disposed with an irregular spacing on the outer circumference of the tool basic body 2. Provided between the cassettes 4 in the tool basic body 2, in the region of the circumferential surface 3, there are chip guide flutes 6. The latter directly adjoin chip guide surfaces 7, which are integrated into each cassette 4.

Each cassette 4 is attached to the tool basic body 2 in a receiver 21 that closely surrounds the respective cassette 4. Provided for the purpose of fastening to the tool basic body there is a fastening screw 23, which extends through the cassette 4. An adjusting screw 32 is assigned to each cassette, for precise setting of the position of the cassette.

In respect of further details of the mounting of the cassettes 4 and their adjustment on the milling cutter 1, reference is made to EP 1 753 577.

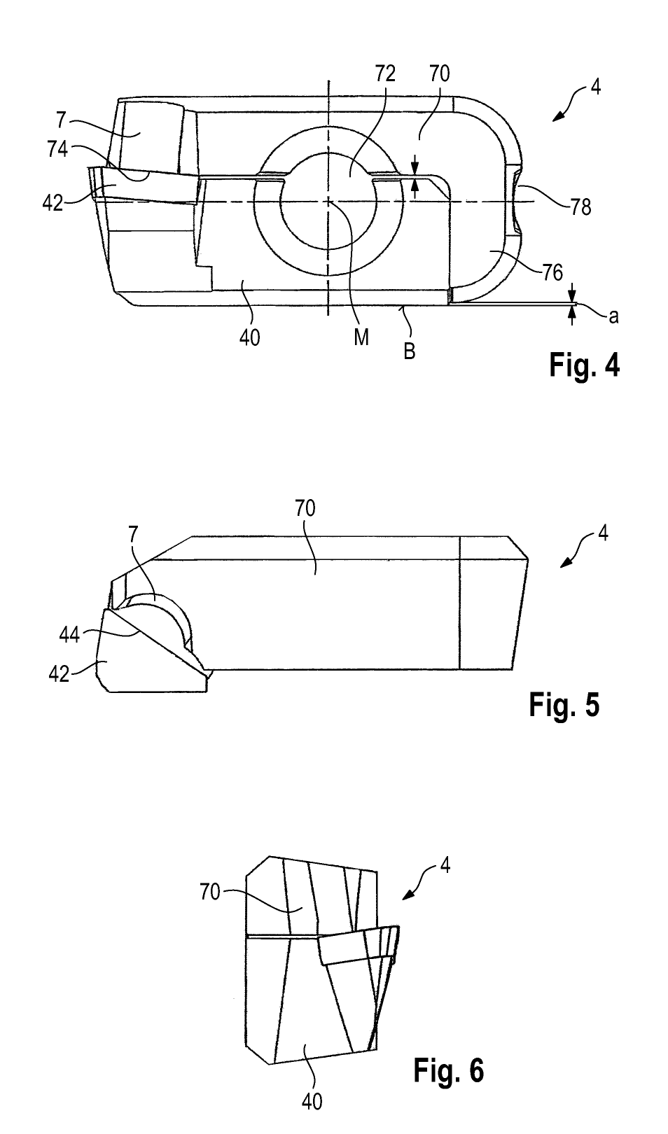

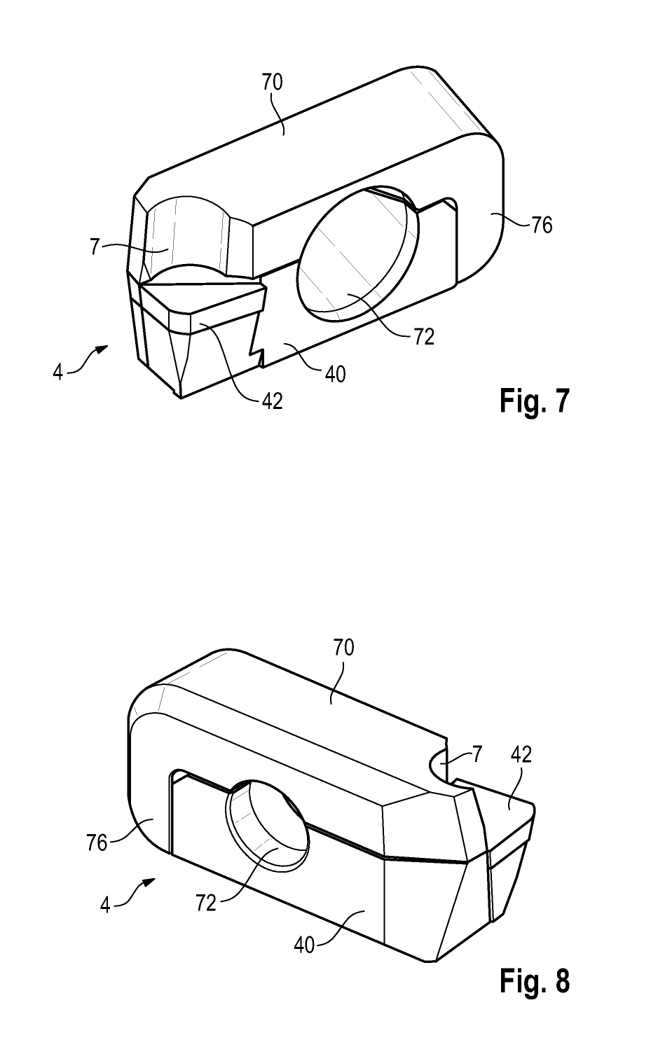

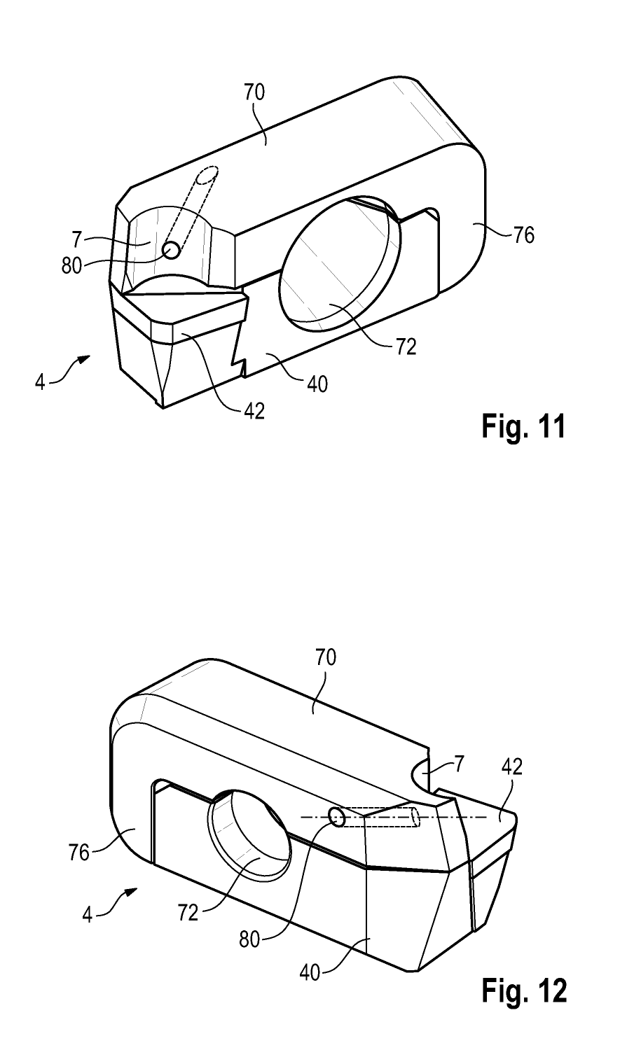

FIGS. 4 to 10 show a first embodiment of the cassettes 4. Each cassette consists of a cutter carrier 40 and a clamping part 70, which are realized as discrete, separate components and, when put together, result in the generally rectangular cassette (see FIG. 4), through which there extends a fastening opening 72.

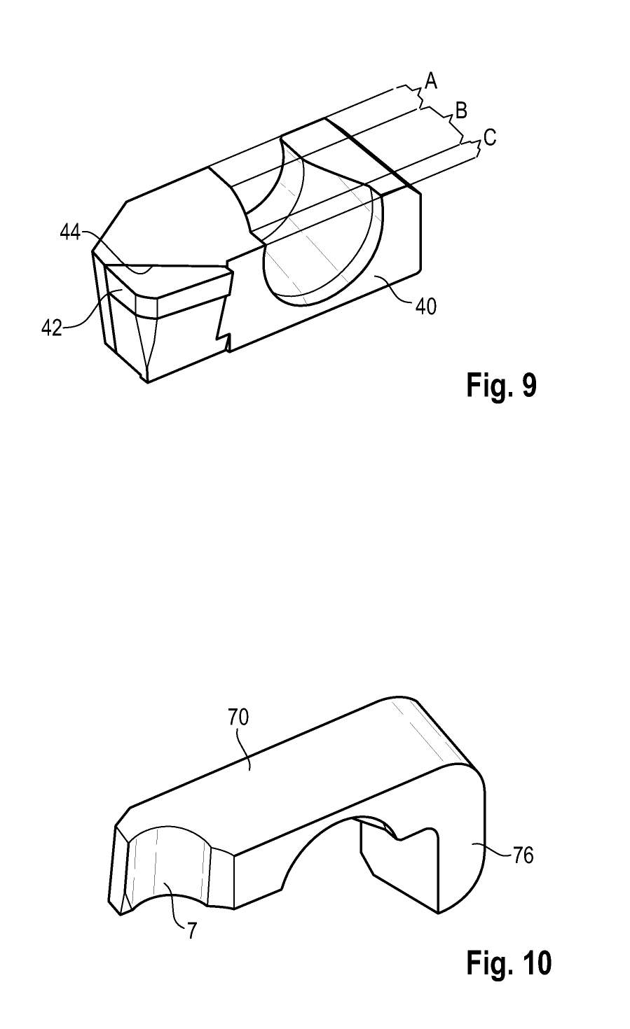

The cutter carrier 40 itself is again generally rectangular (see FIG. 9), and at one corner has a cutting insert 42, which is fixedly connected here to the cutter carrier 40. The cutting insert 42 can be composed, for example, of polycrystalline diamond, and can be soldered or adhesive-bonded into an appropriately shaped seat 44 on the cutter carrier 40.

The cutter carrier 40 is additionally provided with a recess, which is part of the fastening opening 72. As can be seen in FIG. 4, the center axis M of the fastening opening 72 is located beneath the parting plane between the cutter carrier 40 and the clamping part 70, such that the distance between the two edges of the recess for the fastening opening, measured at the edge of the cutter carrier 40 that, in relation to the figures, is the upper edge, is less than the diameter of the fastening opening. The fastening opening itself has a portion A of a constant diameter, which defines the smallest diameter of the fastening opening, a portion B, which widens in the form of a wedge, and a portion C, which again is of a constant diameter.

Insofar as terms such as “top”, “bottom”, “front”, etc. are used here, these relate merely to the representation in the drawings. In practice, the cassette can be used in any optional orientation and, when in use, the spatial orientation alters in dependence on the orientation and rotation of the milling cutter.

The clamping part 70, as viewed in a side view, has a general L shape and, on one side, has a clamping surface 74, which is provided to be supported on the cutter carrier 40, and at the opposite end has a support portion 76, which encompasses the outside of the cutter carrier 40 that faces away from the cutting insert 42.

At its front end that faces away from the support portion 76, the clamping part 70 is provided with a chip guide surface 7. The latter terminates at a short distance from the seat 44 for the cutting insert 42.

Furthermore, in the clamping part 70, the “rest” of the fastening opening 72 is provided in the form of a recess.

When the clamping part 70 has been placed on the cutter carrier 40 (see, in particular, FIG. 4), the support portion 76 terminates at a short distance a above the plane that is defined by the bottom surface F of the cutter carrier 40. As a result, the outer contour of the cassette 4, in relation to FIG. 4, is defined, on the top side and back side of the cassette, solely by the outer faces of the clamping part 70 and, on the underside, solely by the bottom surface B of the cutter carrier 40. In particular, a continuous, homogeneous bearing surface 78 is thereby obtained in the region of the adjusting screw 32. The dimensions of the cutter carrier 40 and of the clamping part 70 are selected such that the clamping part 70 is supported on the cutter carrier 40 only in the region of the clamping surface 74, i.e. at its front end, and there is otherwise a gap S, between the cutter carrier 40 and the clamping part 70, that, starting from the clamping surface 74, extends beyond the region of the fastening opening 72 and into the region in which the support portion 76 is located.

The cassette 4 is inserted in the corresponding receiver 21 of the milling cutter 1 such that the cutting insert 42 is located on the outside. The cassette is fastened in the cassette by means of the fastening screw 23, the fastening screw 23, as such, tending to force apart the two parts, cutter carrier 40 and clamping part 70. Owing to the dimensions and shape of the receiver 21, however, the two parts are held fixedly together as a unit, and can be appropriately adjusted in the receiver.

If the cutting insert 42 has become worn, it can either be remachined or replaced together with the cutter carrier 40. The clamping part 70, however, can continue to be used in each case.

FIG. 11 shows a cassette according to a second embodiment. The difference in relation to the first embodiment consists in that provided in the clamping part 70 there is a coolant channel 80, which extends between the chip guide surface 7 and, in relation to FIG. 11, the top side of the clamping part 70. As a result, when the cassette 4 has been mounted in the milling cutter 1, coolant can be directed specifically to the cutting insert 42, via a coolant supply opening, which is disposed in one of the side surfaces of the receiver 21 of the milling cutter.

FIG. 12 shows a third embodiment, which differs from the second embodiment in the disposition of the coolant channel 80. In the case of the third embodiment, the coolant channel 80 terminates on a side surface of the cassette 4, such that the coolant can be directed to the cutting insert 42 or, more precisely, to the cutting edge thereof, via a coolant supply opening provided on the bottom of the receiver 21 in the milling cutter 1.

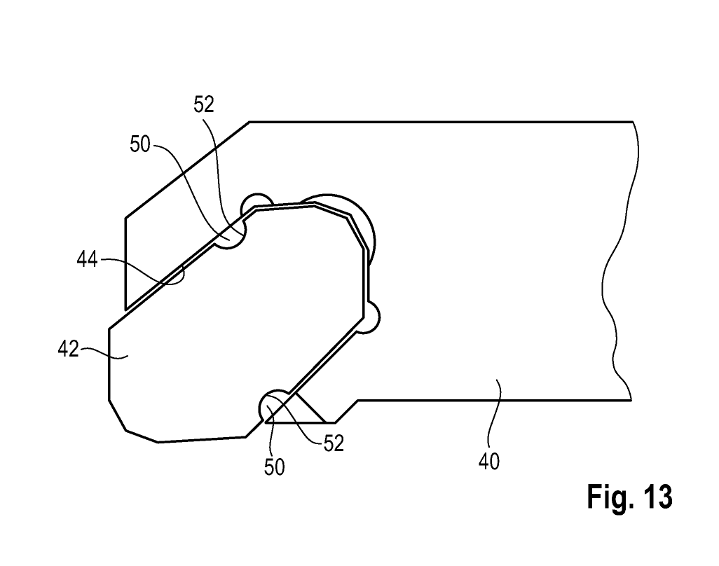

FIG. 13 shows a fourth embodiment, which differs from the first three embodiments in respect of the cutting insert 42. In the case of the fourth embodiment, the cutting insert 42 is not fixedly soldered-in, but is realized as an indexable cutting insert, which is inserted in the seat 44. There, it is fixed by means of the clamping action exerted by the clamping part 70 and, in particular, by the clamping surface 74 thereof.

In addition, the cutting insert 42 is locked positively in the seat 44. For this purpose, retaining projections 50 are provided on the seat, which projections engage in appropriate recesses 52 on the cutting insert 42.

In the case of the fourth embodiment, likewise, coolant channels can be provided in the clamping part 70.

1. A cassette for a milling cutter, having a cutter carrier and a clamping part, which together constitute a generally rectangular cassette, the cutter carrier and the clamping part being loosely placed on each other and together delimiting a fastening opening for a fastening screw by means of which the cassette can be fastened in a receiver of a milling cutter, the cutter carrier having a seat for a cutting insert.

2. The cassette as claimed in claim 1, wherein the cutting insert is fixedly mounted on the cutter carrier, in particular soldered or adhesive-bonded into the seat.

3. The cassette as claimed in claim 1, wherein the cutting insert is inserted in the seat on the cutter carrier.

4. The cassette as claimed in claim 3, wherein the cutting insert is locked positively, in the seat, against displacement in at least one direction.

5. The cassette as claimed in claim 1, wherein the clamping part has a support portion, which defines an outside face of the cassette that faces away from the seat for the cutting insert.

6. The cassette as claimed in claim 5, wherein the support portion terminates just above the bottom surface of the cutter carrier.

7. The cassette as claimed in claim 1, wherein the parting line between the cutter carrier and the clamping part, in relation to a center line of the fastening opening, runs closer to the clamping part than to the cutter carrier.

8. The cassette as claimed in claim 1, wherein the clamping part has a clamping surface that is located at the end of the clamping part facing away from the support portion, and that is supported on the cutter carrier in the region of the seat, or close to the latter.

9. The cassette as claimed in claim 1, wherein there is a slot between the cutter carrier and the clamping part, which slot extends, starting from the clamping surface, beyond the region of the fastening opening, to the support portion.

10. The cassette as claimed in claim 1, wherein at least one coolant channel is provided in the clamping part.

11. The cassette as claimed in claim 10, wherein the coolant channel extends from a side surface of the clamping part to an outer surface of the clamping part that is disposed above the seat for the cutting insert.

12. The cassette as claimed in claim 10, wherein the coolant channel extends from a top side of the clamping part to an outer surface of the clamping part that is disposed above the seat for the cutting insert.

13. A milling cutter having at least one receiver for a cassette and having at least one cassette according to claim 1.
